(19) United States
(12) Patent Application Publication
(10) Pub. No.: US 2025/0381518 A1
(43) Pub. Date: Dec. 18, 2025

(54) DAC PLANT

(71) Applicant: MAN Energy Solutions SE, Augsburg (DE)

(72) Inventors: Klaus BEHNKE, Schriesheim (DE); Stephan WEBER, Herten (DE)

(21) Appl. No.: 19/231,754

(22) Filed: Jun. 9, 2025

(30) Foreign Application Priority Data
Jun. 14, 2024 (DE) 10 2024 116 744.0

(51) Int. Cl. B01D 53/62; B01D 53/06; B01D 53/26

(52) U.S. Cl. CPC B01D 53/62; B01D 53/06; B01D 53/261; B01D 2257/504

(57) ABSTRACT

A DAC plant for extracting carbon dioxide from ambient air, having a first air flow channel for ambient air, from which carbon dioxide is extracted, a system for drying the ambient air, a carbon dioxide extraction device for extracting carbon dioxide, and a second air flow channel for waste air. The system includes a first rotating storage body, which carries an adsorbent for water and is driven such that segments of the storage body are periodically in operative flow connection with the first second air flow channels. The carbon dioxide extraction device includes at least one second rotating storage body, which carries an adsorbent for carbon dioxide. The second rotating storage body is driven such that segments of the storage body are periodically in operative flow connection with the first air flow channel and a carrier gas flow channel.

### BACKGROUND OF THE INVENTION

### 1. Field of the Invention

The disclosure relates to a direct air capture (DAC) plant for extracting carbon dioxide from ambient air.

### 2. Description of Related Art

DAC plants serve for extracting carbon dioxide from ambient air. DAC is an abbreviation for direct air capture. For extracting carbon dioxide from the ambient air, the ambient air, in DAC plants known from practice, flows through a carbon dioxide extraction device, which extracts carbon dioxide from the ambient air. The carbon dioxide extraction device of a DAC plant, which serves for extracting carbon dioxide from the ambient air, can be based on different operative mechanisms. Accordingly, carbon dioxide extraction devices of DAC plants are known from practice, which are based on the principle of physical adsorption, chemical adsorption, electrochemical separation, separating method by membranes or even on the principle of cryogenic separating technology. In particular when the carbon dioxide extraction device of a DAC plant is based on the principle of physical adsorption, i.e. utilises physisorbents as adsorbent, it is important that the ambient air is dried beforehand. Thus, DAC plants, the carbon dioxide extraction device of which is based in particular on the principle of physical adsorption, comprise a system for drying the ambient air prior to feeding the same to the carbon dioxide extraction device and, thus, prior to the extraction of the carbon dioxide. For drying ambient air, different methods are known from practice. Accordingly, water or water vapour can be condensed out below the dew point temperature by cooling down the ambient air. Other air drying methods can utilise the principle of physisorption in order to at least partially remove the water from the air via physical adsorption for air drying.

From the article “Investigation of Desiccants and CO₂ Sorbents for Exploration Systems 2016-2017, James C. Knox et al., 47th International Conference on Environmental Systems 16-20 Jul. 2017, Charleston, South Carolina, USA (ICES-2017-188)” a plant for the at least partial removal of carbon dioxide from air is known for use in space exploration. In this plant, air, from which carbon dioxide is to be at least partially removed, is additionally dried and subsequently conducted via a carbon dioxide extraction device. There, both the drying of the air and also the separation of the carbon dioxide from the air is based on the principle of physisorption. There, the drying of the air is based on utilising a solid sorbent bed in the so-called temperature oscillation method. This is highly energy-intensive.

US 2023/0 182 067 A1 discloses a drying device with a rotating storage body. US 2005/0 217 481 A1 discloses a device for drying, cleaning and separating gases with a rotating adsorbent. Further, reference is made to EP 3 431 890 B1.

### SUMMARY OF THE INVENTION

Starting out from this, one aspect of the invention is based on creating a new type of DAC plant.

In the DAC plant for extracting carbon dioxide from ambient air according to one aspect of the invention, the system for drying the ambient air comprises at least one first rotating storage body, which carries an adsorbent for water, wherein the respective first rotating storage body can be rotatingly driven in such a manner that as a consequence of its rotation, segments of the same storage body are periodically in operative flow connection with the first air flow channel and periodically with the second air flow channel.

In the DAC plant for extracting carbon dioxide from ambient air according to one aspect of the invention, the carbon dioxide extraction device comprises at least one second rotating storage body, which carries an adsorbent for carbon dioxide, wherein the respective second rotating storage body can be rotatingly driven in such a manner that as a consequence of its rotation, segments of the same storage body are periodically in operative flow connection with the first air flow channel and periodically with a carrier gas flow channel.

The DAC plant according to one aspect of the invention comprises the system for drying the ambient air, which comprises the at least one first rotating storage body, which carries an adsorbent for water.

The respective first rotating storage body can be rotatingly driven in such a manner that as a consequence of its rotation, segments of the same storage body are periodically in operative connection with the first air flow channel and periodically with the second air flow channel and then, when one of the segments of the respective rotating first storage bodies is in operative flow connection with the first air flow channel, adsorb water by the adsorbent of the respective segment of the respective rotating first storage body out of the ambient air to be dried, and then, when one of the segments of the respective rotating first storage body is in operative flow connection with the second air flow channel, discharge water from the adsorbent of the respective segment of the respective rotating first storage body to the waste air of the carbon dioxide extraction device.

The DAC plant according to one aspect of the invention, further, comprises the carbon dioxide extraction device, which at least comprises the one second rotating storage body, which carries an adsorbent for carbon dioxide.

The respective second rotating storage body can be rotatingly driven in such a manner that as a consequence of its rotation, segments of the same storage body are periodically in operative connection with the first air flow channel and periodically with the second air flow channel carrier gas flow channel, and then, when one of the segments (of the respective rotating second storage body) is in operative flow connection with the first air flow channel, adsorb carbon dioxide through the adsorbent of the respective segment of the respective rotating second storage body from the dried ambient air, and then, when one of the segments of the respective rotating second storage bodies is in operative flow connection with the carrier gas flow channel, discharge carbon dioxide from the adsorbent of the respective segment of the respective rotating second storage body to the carrier gas.

The DAC plant according to one aspect of the invention allows an efficient extraction of carbon dioxide from ambient air. Carbon dioxide can be extracted from ambient air in a continuous, quasi-stationary process. A batch process required to date can thus be avoided. The DAC plant according to one aspect of the invention requires little installation space and few assemblies. A low adsorbent quantity for adsorption both of the water from the ambient air and also of the carbon dioxide from the dried ambient air is required.

According to a first variant of the DAC plant according to one aspect of the invention, the respective second rotating storage body can be rotatingly driven in such a manner that as a consequence of its rotation the segments of the same storage body are periodically in operative flow connection with the first air flow channel, thereafter periodically with the carrier gas flow channel, thereafter periodically with the second air flow channel and thereafter again periodically with the first air flow channel. In particular, when one of the segments of the respective rotating second storage body is in operative flow connection with the second air flow channel, the adsorbent of the respective segment of the respective second rotating storage body is cooled and/or dried.

According to the first variant of the DAC plant according to one aspect of the invention, the same preferentially comprises a redirection flow channel in order to redirect air, emanating from the segment of the respective rotating second storage body of the carbon dioxide extraction device in operative flow connection with the first air flow channel, in the direction of the segment of the respective rotating second storage body of the carbon dioxide extraction device in operative flow connection with the second air flow channel.

The first variant of the DAC plant according to one aspect of the invention is then preferred when as carrier gas in particular water vapour is utilised.

According to a second variant of the DAC plant according to one aspect of the invention, the respective second rotating storage body of the carbon dioxide extraction device can be rotatingly driven in such a manner that as a consequence of its rotation, segments the same are periodically in operative flow connection with the first air flow channel and thereafter periodically with the carrier gas flow channel and thereafter again periodically with the first air flow channel.

According to the second variant of the DAC plant according to one aspect of the invention, in particular when one of the segments of the respective second rotating storage body of the carbon dioxide extraction device is in operative flow connection with the first air flow channel, the same segment of the respective second rotating storage body of the carbon dioxide extraction device is also directly in operative flow connection with the second air flow channel.

The second variant of the DAC plant according to one aspect of the invention is preferred, in particular when as carrier gas, in particular, hydrogen is utilised.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

FIG. 1: is a highly schematised representation of a DAC plant; and

FIG. 2: is a highly schematised representation of a DAC plant.

### DETAILED DESCRIPTION OF THE PRESENTLY PREFERRED EMBODIMENTS

A DAC plant 10 comprises a first air flow channel 11, wherein this first air flow channel 11 serves for conducting ambient air from which carbon dioxide is to be extracted.

Furthermore, the DAC plant 10 comprises a system 12 for drying the ambient air, from which carbon dioxide is to be extracted, wherein the system 12 for drying the ambient air comprises at least one first rotating storage body 12a, 12b, which carries an adsorbent for water.

As shown, two first rotating storage bodies 12a, 12b for drying the ambient air are present, each of which carry an adsorbent for water and are connected in series.

Furthermore, the DAC plant 10 comprises a carbon dioxide extraction device 13, which serves for extracting the carbon dioxide from the dried ambient air. The carbon dioxide extraction device 13 comprises at least one second rotating storage body 13a, which carries an adsorbent for carbon dioxide.

As shown, the carbon dioxide extraction device 13 comprises a single rotating storage body 13a with an adsorbent for carbon dioxide.

The DAC plant 10, furthermore, comprises a second air flow channel 14 for waste air of the carbon dioxide extraction device 13.

As already explained, the system 12 for drying the ambient air comprises at least one first rotating storage body 12a, 12b. The respective first rotating storage body 12a, 12b can be rotatingly driven in such a manner that as a consequence of its rotation, segments 15, 16 of the same storage body are periodically in operative flow connection with the first air flow channel 11 and periodically with the second air flow channel 14.

In particular, when one of the segments 15, 16 of the respective first rotating storage body 12a, 12b is in operative flow connection with the first air flow channel 11, the same is preferentially positioned in the first air flow channel 11. In particular, when one of the segments 15, 16 of the respective first rotating storage body 12a, 12b is in operative flow connection with the second air flow channel 14, the same is preferentially positioned in the second air flow channel 14.

In particular, when one of the segments 15, 16 of the respective first rotating storage body 12a, 12b is in operative flow connection with the first air flow channel 11, the other of the segments 15, 16 of the respective first rotating storage body 12a, 12b is preferentially in operative flow connection with the second air flow channel 14.

In particular, when a respective segment 15, 16 of the respective rotating first storage body 12a, 12b is positioned in the first air flow channel 11, water can be adsorbed by the adsorbent of the respective segment 15, 16 of the first rotating storage body 12, 12a from the ambient air to be dried.

In particular, when the respective segment 15, 16 of the respective rotating first storage body 12a, 12b is positioned in the second air flow channel 14, water from the adsorbent of the respective segment 15, 16 of the respective first rotating storage body 12a, 12b can be discharged to the waste air of the carbon dioxide extraction device 13.

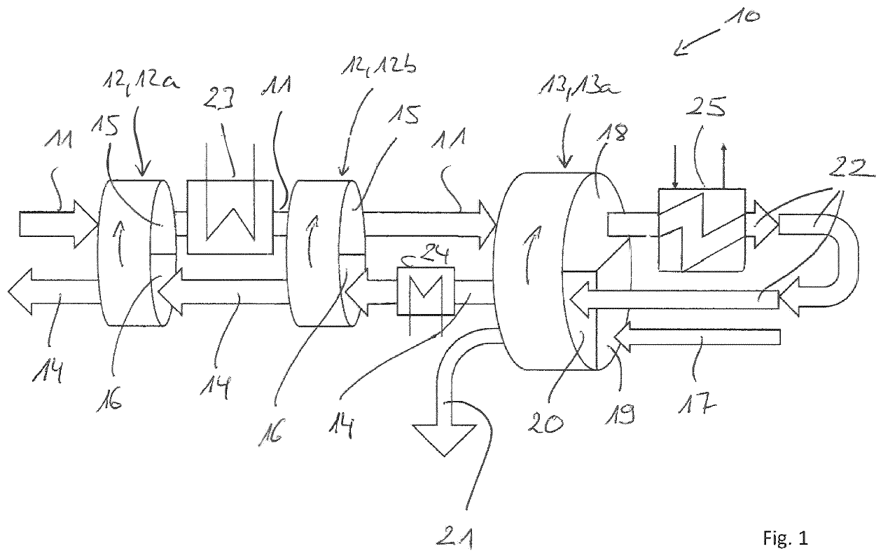

The second rotating storage body 13a of the carbon dioxide extraction device 13 shown in FIG. 1 can likewise be rotatingly driven, namely in such a manner that as a consequence of its rotation, segments 18, 19, 20 of the same storage body are periodically in operative flow connection with the first air flow channel 11 and periodically with a carrier gas flow channel 17.

In particular, when one of the segments 18, 19, 20 of the respective second rotating storage body 13a is in operative flow connection with the first air flow channel 11, the same is preferentially positioned in the first air flow channel 11. In particular, when one of the segments 18, 19, 20 of the respective second rotating storage body 13a is in operative flow connection with the carrier gas flow channel 17, the same is preferentially positioned in the carrier gas flow channel 17.

In particular, when a respective segment 18, 19, 20 of the second rotating storage body 13a is positioned in the first air flow channel 11 or is in operative flow connection with the same, carbon dioxide can be adsorbed by the adsorbent of the respective segment of the rotating second storage body 13a from the dried ambient air.

In particular, when the respective segment 18, 19, 20 of the second rotating storage body 13a is positioned in the carrier gas flow channel 17 or is in operative flow connection with the same, the carbon dioxide can be discharged from the adsorbent of the respective segment of the rotating second storage body 13a to the carrier gas.

In FIG. 1, the rotating second storage body 13a of the carbon dioxide extraction device 13 comprises three segments 18, 19 and 20, wherein the second rotating storage body 13a of the carbon dioxide extraction device 13 of FIG. 1 can be rotatingly driven in such a manner that as a consequence of its rotation the segments 18, 19, 20 of the same storage body are periodically in operative flow connection with the first air flow channel 11, thereafter periodically with the carrier gas flow channel 17, thereafter periodically with the second air flow channel 14 and thereafter, again periodically with the first air flow channel 17.

In particular, when one of the segments 18, 19, 20 of the rotating second storage body 13a of the carbon dioxide extraction device 13 is in operative flow connection with the second air flow channel 14, the adsorbent of the respective segment of the second rotating storage body 13a in operative flow connection with the second air flow channel 14 is cooled and/or dried.

When the respective segment 18, 19, 20 of the rotating second storage body 13a is arranged in the first air flow channel 11 or is in operative flow connection with the same, the adsorbent of the respective segment 18, 19, 20 adsorbs carbon dioxide from the dried ambient air.

When the respective segment 18, 19, 20 of the rotating second storage body 13a is arranged in the carrier gas flow channel 17 or is in operative flow connection with the same, the adsorbent of the respective segment 18, 19, 20 of the rotating second storage body 13 discharges carbon dioxide to the carrier gas so that via a discharge line 21 a mixture of carrier gas and carbon dioxide flows out.

The carrier gas is a carbon dioxide-free carrier gas, in FIG. 1, in particular, water vapour.

In particular, when in FIG. 1 the respective segment 18, 19, 20 of the rotating second storage body 13a is arranged in the region of the second air flow channel 14 or is in operative flow connection with the same, the adsorbent of the respective segment of the second rotating storage body 13 can be cooled and/or dried, wherein then for this purpose according to FIG. 1 air is redirected via a redirection flow channel 22 from the first air flow channel 11 in the direction of the second air flow channel 14, namely upstream of the carbon dioxide extraction device 13. By way of the redirection flow channel 22, air emanating from the segment 18, 19, 20 of the rotating second storage body 13a of the carbon dioxide extraction device 13, which segment 18, 19, 20 is in operative flow connection with the first air flow channel 11, is redirected in the direction of the segment of the rotating second storage body 13a of the carbon dioxide extraction device 13, which segment 18, 19, 20 is in operative flow connection with the second air flow channel 14. In particular, when one of the segments 18, 19, 20 of the second rotating storage body 13a of the carbon dioxide extraction device 13 is in operative flow connection with the first air flow channel 11, this segment is in operative flow connection with via the redirection flow channel 22 with another of the segments of the second rotating storage body 13a, which segment is in operative flow connection with the second air flow channel 14.

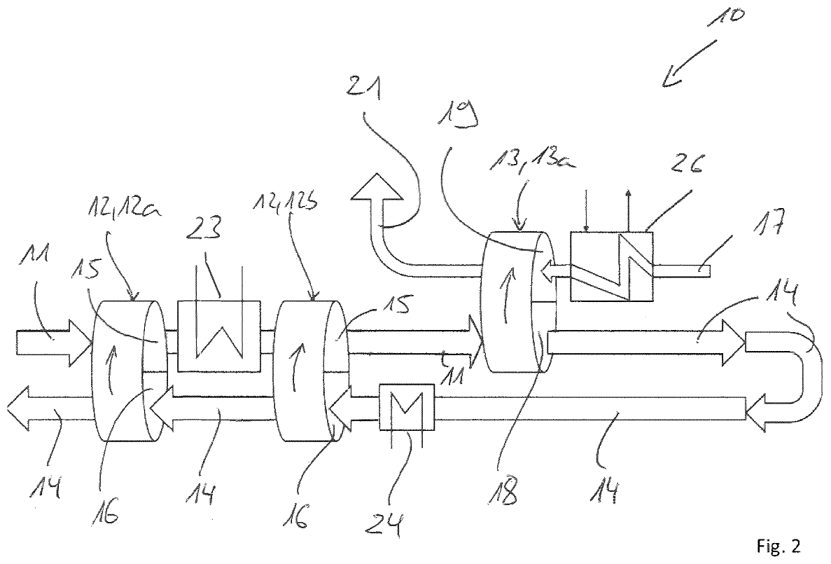

Compared with this, FIG. 2 shows a variant of a DAC plant 10, in which the second rotating storage body 13a of the carbon dioxide extraction device 13 merely comprises two segments 18, 19, wherein the second rotating storage body 13a can be rotatingly driven in such a manner that as a consequence of its rotation the segments 18, 19 of the same storage body are periodically arranged in the first air flow channel 11 and periodically in the carrier gas flow channel 17. This variant is preferred, in particular, when as carrier gas hydrogen is utilised and no drying of the adsorbent of the second rotating storage body 13a is required.

In particular, when in FIG. 2 one of the segments 18, 19 of the second rotating storage body 13a of the carbon dioxide extraction device 13 is in operative flow connection with the first air flow channel 11, this segment 18, 19 of the respective second rotating storage body 13a of the carbon dioxide extraction device 13 is also directly in operative flow connection with the second air flow channel 14. Then, this segment is arranged both in the first air flow channel 11 and simultaneously also in the second air flow channel 14.

In the region of the first rotating storage body 12a, 12b of the system 12 for drying the ambient air, preferentially an adsorbent for the physisorption of water is employed as adsorbent, which can be for example a silica gel or a zeolite.

In the second rotating storage body 13a of the carbon dioxide extraction device 13, an adsorbent for the physisorption or chemisorption is preferentially employed as adsorbent, wherein a chemisorbent can be received in an MOF.

In the carbon dioxide extraction device 13, the desorption, namely the discharge of the carbon dioxide to the carrier gas, is substantially based on a different CO₂ partial pressure between the partial pressure in the adsorbent and the partial pressure in the carrier gas.

In FIGS. 1 and 2, the system 12 for drying the ambient air comprises the two rotating storage bodies 12a, 12b, wherein between the same in the region of the first air flow channel 11 a heating device 23 for heating the ambient air to be dried is provided between the two first rotating storage bodies 12a, 12b. This heating device 23 is optional.

In FIGS. 1 and 2, a cooling device 24 each is shown upstream of the rotating storage body 12b, in order to cool the waste air of the carbon dioxide extraction device 13. The cooling device 24 is optional.

In the exemplary embodiment of FIG. 1, the redirection flow channel 22 is assigned a heating device 25 in order to heat the air redirected via the carbon dioxide extraction device 13. In FIG. 2 by contrast, a heating device 26 is assigned to the carrier gas flow channel 17 in order to heat the carrier gas upstream of the carbon dioxide extraction device 13.

Accordingly, the DAC plant 10 according to one aspect of the invention utilises in the region of the system 12 for drying the ambient air and in the region of the carbon dioxide extraction device 13, at least one rotating storage body each. The respective rotating storage body carries an adsorbent, namely in the region of the at least one first rotating storage body 12, 12b of the system 12 for drying the ambient air an adsorbent for water and in the region of the rotating storage body 13a of the carbon dioxide extraction device 13, an adsorbent for adsorption of CO₂.

The DAC plant according to the invention serves for the continuous extraction of carbon dioxide from ambient air in a quasi-stationary method.

The space requirement of the DAC plant 10 is low, few assemblies are needed and the quantity of the required adsorbent is also low.

An efficient extraction of carbon dioxide CO₂ from ambient air is possible.

Thus, while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A direct air capture (DAC) plant configured to extract carbon dioxide from ambient air, comprising:
a first air flow channel for the ambient air, from which the carbon dioxide is to be extracted;
a system configured to dry the ambient air, from which the carbon dioxide is to be extracted and comprises at least one first rotating storage body, which carries an adsorbent for water;
a carbon dioxide extraction device configured to extract the carbon dioxide from the dried ambient air and comprises at least one second rotating storage body, which carries an adsorbent for carbon dioxide;
a second air flow channel for waste air of the carbon dioxide extraction device,
wherein the first rotating storage body can be rotatingly driven such that as a consequence of its rotation, segments of the first rotating storage body are periodically in operative flow connection with the first air flow channel and periodically with the second air flow channel,
wherein the second rotating storage body can be rotatingly driven such that, as a consequence of its rotation, segments of the second rotating storage body are periodically in operative flow connection with the first air flow channel and periodically with a carrier gas flow channel.

2. The DAC plant according to claim 1,
wherein when one of the segments of the rotating first storage body is in operative flow connection with the first air flow channel, the adsorbent of the respective segment of the respective rotating first storage body adsorbs water from the ambient air to be dried,
wherein when one of the segments of the respective rotating first storage body is in operative flow connection with the second air flow channel, the adsorbent of the respective segment of the respective rotating first storage body discharges water to the waste air of the carbon dioxide extraction device.

3. The DAC plant according to claim 1, wherein
wherein, when one of the segments of the rotating second storage body is in operative flow connection with the first air flow channel, the adsorbent of the respective segment of the rotating second storage body adsorbs carbon dioxide from the dried ambient air,
wherein when one of the segments of the rotating second storage body is in operative flow connection with the carrier gas flow channel, the adsorbent of the respective segment of the rotating second storage body discharges carbon dioxide to the carrier gas.

4. The DAC plant according to claim 1, wherein
the second rotating storage body is rotatingly driven such that as a consequence of rotation, the segments of the second rotating storage body are periodically in operative flow connection with the first air flow channel, thereafter periodically with the carrier gas flow channel, thereafter periodically with the second air flow channel and thereafter again periodically with the first air flow channel, and
then, when one of the segments of the rotating second storage body is in operative flow connection with the second air flow channel, cool and/or dry the adsorbent of the respective segment of the second rotating storage body is in operative flow connection with the second air flow channel.

5. The DAC plant according to claim 4, further comprising:
a redirection flow channel, configured to redirect air emanating from the segment of the respective rotating second storage body of the carbon dioxide extraction device that is in operative flow connection with the first air flow channel, in a direction of the segment of the rotating second storage body of the carbon dioxide extraction device that is in operative flow connection with the second air flow channel.

6. The DAC plant according to claim 5, wherein
when one of the segments of the second rotating storage body of the carbon dioxide extraction device is in operative flow connection with the first air flow channel, the one segment is in operative flow connection with via the redirection flow channel with another of the segments of the second rotating storage body of the carbon dioxide extraction device, that segment that is in operative flow connection with the second air flow channel.

7. The DAC plant according to claim 4, wherein the carrier gas is water vapour.

8. The DAC plant according to claim 1, wherein
the second rotating storage body of the carbon dioxide extraction device is rotatingly driven such a that as a consequence of its rotation, segments of the second rotating storage body are periodically in operative flow connection with the first air flow channel and thereafter periodically with the carrier gas flow channel and thereafter again periodically with the first air flow channel.

9. The DAC plant according to claim 8, wherein
when one of the segments of the second rotating storage body of the carbon dioxide extraction device is in operative flow connection with the first air flow channel, the one segment of the second rotating storage body of the carbon dioxide extraction device is also directly in operative flow connection with the second air flow channel.

10. The DAC plant according to claim 9, wherein the carrier gas is hydrogen.

11. The DAC plant according to claim 1, wherein
the system for drying the ambient air comprises multiple first rotating storage bodies connected in series, and
a heating device for heating the ambient air is arranged in the first air flow channel between two first rotating storage bodies connected in series.

12. The DAC plant according to claim 1, further comprising:
a cooling device configured to cool the waste air of the carbon dioxide extraction device is arranged in the second air flow channel downstream of the or each second rotating storage body and upstream of the or each first rotating storage body.

13. The DAC plant according to claim 1, wherein
the first storage body carries an adsorbent for physisorption of water.

14. The DAC plant according to claim 1, wherein
the second storage body carries an adsorbent for physisorption or chemisorption of carbon dioxide.

15. The DAC plant according to claim 1, configured for continuous extraction of the carbon dioxide from the ambient air.
